(19) United States
(12) Patent Application Publication
(10) Pub. No.: US 2015/0078838 A1
(43) Pub. Date: Mar. 19, 2015

(54) HORIZONTAL CONNECTION FOR MECHANICALLY STABILIZED EARTH WALLS

(71) Applicant: Kenneth Shaw, Flower Mound, TX (US)

(72) Inventor: Kenneth Shaw, Flower Mound, TX (US)

(21) Appl. No.: 14/030,971

(22) Filed: Sep. 18, 2013

(51) Int. Cl. E02D 29/02; F16B 5/12

(52) U.S. Cl. CPC E02D 29/025; F16B 5/12
USPC 405/284; 24/713.6

(57) ABSTRACT

An improved method for attaching a geosynthetic strip to a plurality of fact panels of a retaining wall. The method first begins by providing a plurality of stackable face panels, each face panel having a plurality of connector loops fixed with the back portion of the face panels. Each of the connector loops for a horizontal loop extending outwardly generally perpendicular to the back portion of the face panel. Next, a first tier of face panels is disposed at the bottom of the embankment being erected. Soil is then back-filled behind the first tier of panels to a level of the connector loops disposed within the first tier of face panels. A geosynthetic strip, which extends perpendicularly from the back portion of the face panels into the soil embankment, is positioned so that a plurality of geosynthetic strips aligns with the connection loops. Next, additional soil is back-filled behind the first tier of face panels and covers the connection links and geosynthetic strips to a level at a top edge of the first tier of face panels. The method is repeated until the desired height of the embankment is attained.

### RELATED U.S. APPLICATION DATA

Provisional application No. 61/703,611 filed on Sep. 20, 2012

### REFERENCES CITED

U.S. PATENT DOCUMENTS

| | |
|---|---|
| 3,686,873 | 8/1972 Vidal |
| 4,116,010 | 9/1978 Vidal |
| 4,324,508 | 4/1982 Hilfiker et al. |
| 4,449,857 | 5/1984 Davis |
| 4,470,728 | 9/1984 Broadbent |
| 4,725,170 | 2/1998 Davis |
| 4,929,125 | 5/1990 Hilfiker |
| 4,952,098 | 8/1990 Grayson et al. |
| 4,993,879 | 2/1991 Hilfiker |
| 5,044,833 | 9/1991 Hilfiker |
| 5,131,791 | 7/1992 Kitziller |
| 5,259,704 | 11/1993 Ogorchok |
| 5,451,120 | 9/1995 Martinez-Gonzalez |
| 5,975,810 | 11/1999 Taylor et al. |
| 6,186,703 | 2/2001 Shaw |

### BACKGROUND OF THE INVENTION

1. Technical Field of Invention

This invention relates to an improved method for use with earth retaining structures, and more particularly, an improved method of connecting geosynthetic strips to the face panels of the wall. This utility patent application claims the priority date of Provisional Patent Application Ser. No. 61/703,611 filed Sep. 20, 2012 and is hereby incorporated by reference.

2. Description of Related Art

A retaining wall is used for retaining earth and/or other backfill material placed behind the wall. Elongated support structures normally extend from various locations on the back surface of the wall into the backfill. These support members are embedded into the backfill material to prevent the wall from failing.

The retaining wall may be constructed of cast in place concrete, which can be poured on site, Alternatively, the wall may be constructed of a plurality of modular concrete blocks, which are assembled on site. Generally, modular blocks are less expensive to construct and assemble than a large, single piece of concrete. Additionally, the amount of time required for assembling the modular blocks is generally faster than the time required to place the forms along with the reinforcing steel and pour the concrete.

In the past the galvanized steel has been in a majority of these types of retaining walls for the material that is attached to the panels and extends horizontally into the backfill material. Recently geosynthetic strips have been used more and more due to their inert material composition as well as being more economical. A major difficulty is encountered in attaching either type of material to the modular block face panels. Several methods and apparatus have been provided in the past for attaching the support members to the modular block face panels. However, installation of these prior art devices onto retaining walls is often tedious, costly and time consuming. In addition, difficulties are encountered in providing a strong, economical connecting device connecting the retaining wall with the support members, especially with the use of the newer geosynthetic strips. A system is needed for attaching support members to a modular block, which is easy to install, economical, and provides the requisite strength necessary to reinforce a retaining wall.

Although there are no known prior art teachings of a solution to the aforementioned deficiency and shortcoming such as disclosed herein, prior are references that discuss subject matter that bears some relation to matters discussed herein are U.S. Pat. No. 4,324,508 to Hilfiker et al. (Hilfiker I), U.S. Pat. No. 4,449,857 to Davis (Davis I), U.S. Pat. No. 4,725,170 to Davis (Davis II), U.S. Pat. No. 4,929,125 to Hilfiker (Hilfiker II), and U.S. Pat. No. 6,186,703 to Shaw (Shaw).

Hilfiker I discloses welded wire grid work mats which are positioned within an earthen formation. The mats are secured to precast elongated panels disposed at the face of the earthen formation. The mats serve as anchors for the panels, as well as reinforcing means for the formation. Plural connections secure the mats along the length of the panels. However, the mats may slip within the earthen formation, and Hilfiker I does not teach or suggest utilizing any method to prevent slippage of the grid work mats.

Davis I discloses a connection system for connecting an upright soil retaining wall formed of modular facing panels with a number of soil reinforcement panels formed of parallel wires. The parallel wires terminate in enlarged bulbous portions at one end and are interconnected by perpendicular crossbars. The mesh units are connected in tiers to the retaining wall and rest in the soil behind the wall. The connection is made by a female member embedded into the back side of the panel with internal threads, into a male member which is threadedly received with an internal bore of a suitable size to pass the wires but not the bulbous portions which bear against the forward end of the bolts. With the wires seated within a corresponding male member, the facing panels and mesh units are connected by screwing the mail member into the female member. Davis I suffers from the disadvantage of a complex and time consuming process of threading the mail members into female members in order to connect the wire mesh reinforcement units to the retaining wall.

Davis II discloses a soil reinforcing system which includes an upright soil retaining wall of modular facing panels and a number of horizontal wire mesh reinforcement units. Each unit includes spaced parallel wires ending in hole forming loops and interconnected by perpendicular crossbars. The mesh units are connected in tiers to the retaining wall and rest in the soil behind the wall. The connection of each wire in a mesh unit is made by a clevis member embedded into the back side of the panel and a bolt and nut assembly or an elongated pin member for attaching the wires and the clevis. However, Davis II is a more complex and expensive system than the present invention.

Hilfiker II discloses a reinforced soil embankment having precast face panels with cantilevered sections and extending into the embankment to support the panels in an upright condition. Soil reinforcing elements are secured to the panels to reinforce the embankment and secure the face panels in place. Connectors are provided for securing and reinforcing the elements to the panels. Loops, formed on the ends of the elements, are extended through eyes on the panels formed by wire segments having legs which extend into the face panels. However, Hilfiker I requires very precise alignment of the wire segments embedded in the face panels with the soil reinforcing elements. However, Hilfiker II requires very precise alignment of the wire segments embedded in the face panels with the soil reinforcing elements. Thus, Hilfiker II provides a very inflexible method of attaching soil reinforcing elements to a retaining wall.

Shaw discloses a method and system for attaching a welded wire grid-work panel to a plurality of face panels of a retaining wall with a series of anchor links forming loops that are attached to the panels with a connector rod. While this method is more economical than previous methods, it still requires two loops and a connector rod at each connection point thus making it more expensive, especially when utilizing geosynthetic strips.

### SUMMARY OF THE INVENTION

In one aspect, the present invention is a method of erecting a reinforced soil embankment. The method begins by providing a plurality of stackable face panels, each having a plurality of loops fixed within a back portion of the face panels. In addition, each of the loops form a horizontally oriented opening extending generally perpendicular to the back portion of the panels. A first tier of the face panels is disposed at the bottom of the embankment being erected. Soil is then back-filled behind the first tier of face panels to a level of the loops disposed within the first tier of panels. In the next step, a geosynthetic strip, which extends laterally from the back of the wall into the soil embankment, is positioned so that it can be threaded into the horizontal opening formed by the loops. Next, soil is back-filled behind the first tier of face panels and over the loops and geosynthetic strips to a level at a top edge of the first tier of face panels. The method is then repeated until the desired height of the embankment is attained.

In another aspect, the present invention is an attachment system for attaching a face panel to a geosynthetic strip soil reinforcing system. The system includes a plurality of loops fixed within a back portion of the face panel. Each of the loops forms a horizontal opening extending outwardly generally perpendicular to the back portion of the face panel. The geosynthetic strip is connected to the face panel without the need for a connection rod.

In still another aspect, the present invention is an improved retaining wall loop and strip combination. The combination includes a face panel having a back portion and loop fixed within the back portion of the face panel. The loop forms a horizontally oriented opening extending outwardly generally perpendicular to the back portion of the face panel. The combination also includes a geosynthetic strip that is threaded through the horizontal opening formed by the loop to form a composite system that reinforces the soil and retains the backfill.

### BRIEF DESCRIPTION OF THE DRAWINGS

The invention will be better understood and its numerous objects and advantages will become more apparent to those skilled in the art by reference to the following drawings, in conjunction with the accompanying specification, in which:

FIG. 1 illustrates a perspective view of the loops fixed within a face panel connected to the geosynthetic strip.

FIG. 2 illustrates a top plan view of a plurality of loops and the geosynthetic strip threaded into the horizontal opening formed by the loops.

### DETAILED DESCRIPTION OF EMBODIMENTS

An improved method and system for attaching a geosynthetic strip to a plurality of face panels of a retaining wall is disclosed.

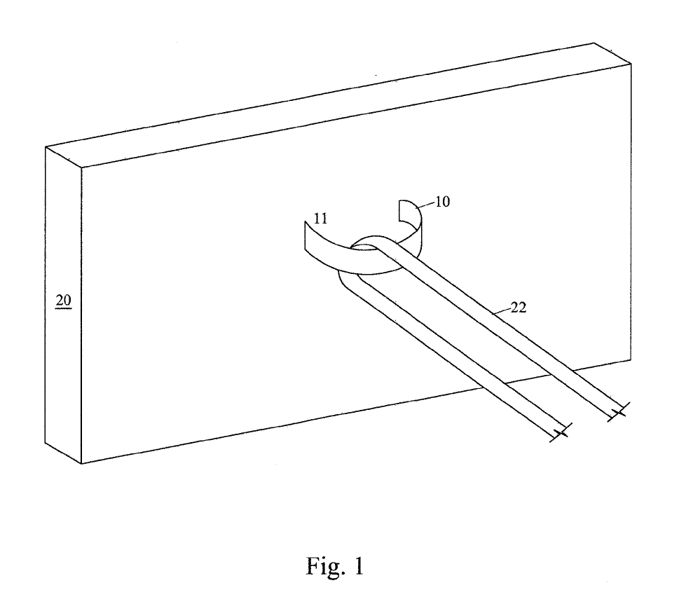

FIG. 1 illustrates a perspective view of a preferred embodiment of a loop 10 of the present invention. The loop forms a horizontal opening 11 in the back of the face panel 20 through which the geosynthetic soil reinforcing strip 22 is threaded.

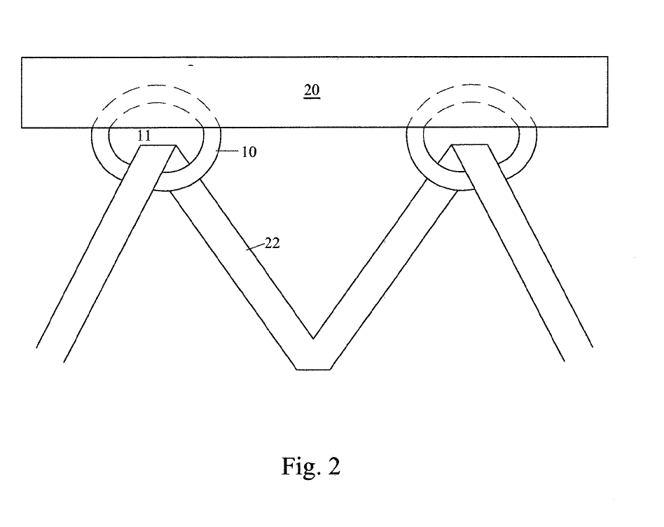

FIG. 2 illustrates a top plan view of the loop 10 embedded into the back of the face panel 20 and the opening 11 which is used to thread the geosynthetic soil reinforcing strip 22.

It is thus believed that the operation and construction of the present invention will be apparent from the foregoing description to someone who is proficient in the art.

What is claimed is:

1. A method of erecting a reinforced soil embankment, the method comprising the steps of:
providing a plurality of stackable face panels, each having a plurality of loops fixed within a back portion of the face panels, each of the loops forming a horizontally oriented opening extending outwardly generally perpendicular to the back portion of the face panels;
disposing a first tier of face panels at a bottom end of the embankment being erected;
back-filling soil behind the first tier of face panels up to a bottom edge of the plurality of loops disposed within the first tier of face panels;
positioning a geosynthetic strip, extending perpendicularly from the back portion of face panels onto the back-filled soil embankment, so that a plurality of strips align with the horizontally oriented loops;
threading the geosynthetic strips into the opening formed by the loops and then back and forth between a plurality of loops and extending into the embankment.

2. The method in claim 1 further comprising, after back-filling soil behind the first tier of face panels, the step of continuing to stack additional tiers of face panels, back-filling soil, threading additional geosynthetic strips through the opening formed by the loops to construct the embankment to a desired height.

3. An attachment system for attaching a face panel to a geosynthetic soil reinforcing strip, the system comprising:
a plurality of loops fixed within a back portion of the face panel, each loop forming a horizontally oriented opening extending outwardly generally perpendicular to a back portion of the face panel.

4. The system in claim 3, wherein the loops form an opening extending outwardly generally perpendicular to a back portion of the face panel wherein a geosynthetic strip can be threaded through the horizontal opening making a mechanical connection between the soil reinforcing strip and the face panel.

5. An improved retaining wall connection combination, the combination comprising
a face panel having a back portion;
a loop fixed within the back portion of said face panel, said loop comprising:
a horizontally oriented opening extending outwardly generally perpendicular to the back portion of said face panel; and
a geosynthetic strip threaded through the horizontal opening and embedded into the embankment and making a mechanical connection to the said face panel.

6. The combination of claim 5, further comprising:
a plurality of loops fixed within the back portion of said face panel;
a plurality of soil reinforcing strips threaded through the horizontal openings formed by said loops; and
wherein the connection between the soil reinforcing strips and the plurality of loops extending from the back portion of said face panel forms a mechanical connection between the face panel and the soil reinforcing strips to connect the two together.
